(19) United States
(12) Patent Application Publication
(10) Pub. No.: US 2025/0164713 A1
(43) Pub. Date: May 22, 2025

(54) ANTENNA DEVICE INCLUDING FIBER ATTACHED GLASS

(71) Applicant: QUALCOMM Incorporated, San Diego, CA (US)

(72) Inventors: Changhan Hobie YUN, San Diego, CA (US); Youngju PARK, InCheon (KR); Doosoub SHIN, Incheon (KR)

(21) Appl. No.: 18/514,225

(22) Filed: Nov. 20, 2023

(51) Int. Cl. G02B 6/42; H01Q 1/22

(52) U.S. Cl. CPC G02B 6/424; G02B 6/4206; G02B 6/4239; G02B 6/4244; G02B 6/4253; H01Q 1/2283

(57) ABSTRACT

A device includes a glass layer and an optical fiber directly attached to the glass layer. The device also includes a photo diode electrically connected to an antenna element. The device further includes a lens coupled to or included within the glass layer and configured to manipulate light exchanged between the optical fiber and the photo diode. The photo diode is configured to convert optical signals from the optical fiber into electrical signals for the antenna element, convert electrical signals from the antenna element to optical signals provided to the optical fiber, or both.

### FIELD

Various features relate to antenna devices.

### BACKGROUND

In conventional antenna devices, alignment sleeves are used to align optical fibers and respective lenses that manipulate light exchanged between the optical fibers and photo diodes. A pitch (e.g., space) between optical fibers has to be large enough to accommodate the alignment sleeves. A larger pitch corresponds to fewer optical fibers and lower data rate supported by the antenna device.

### SUMMARY

Various features relate to integrated circuit devices.

One example provides a device that includes a glass layer, an optical fiber directly attached to the glass layer, and a photo diode electrically connected to an antenna element. The device also includes a lens coupled to or included within the glass layer and configured to manipulate light exchanged between the optical fiber and the photo diode. The photo diode is configured to convert optical signals from the optical fiber into electrical signals for the antenna element, convert electrical signals from the antenna element to optical signals provided to the optical fiber, or both.

Another example provides a method of fabricating a device. The method includes aligning an optical fiber with a lens and a photo diode so the lens is positioned to manipulate light exchanged between the optical fiber and the photo diode. The method also includes directly attaching the optical fiber to a first side of a glass layer that includes or is coupled to the lens. The method further includes electrically connecting the photo diode to an antenna element. The photo diode is configured to convert optical signals from the optical fiber into electrical signals for the antenna element, convert electrical signals from the antenna element to optical signals provided to the optical fiber, or both.

Another example provides a device that includes a glass layer, a plurality of optical fibers directly attached to the glass layer, and a plurality of antenna elements. The device also includes a plurality of photo diodes, a particular photo diode of the plurality of photo diodes electrically connected to a corresponding antenna element of the plurality of antenna elements. The device further includes a plurality of lenses coupled to or included within the glass layer, a particular lens of the plurality of lenses configured to manipulate light exchanged between a particular optical fiber and the particular photo diode. The particular photo diode is configured to convert optical signals from the particular optical fiber into electrical signals for the corresponding antenna element, convert electrical signals from the corresponding antenna element to optical signals provided to the particular optical fiber, or both.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates a cross sectional profile view of an exemplary device that includes fiber attached glass.

FIG. 2 illustrates a cross sectional profile view of an exemplary substrate with embedded passive elements of a device that includes fiber attached glass.

FIG. 3 illustrates a cross sectional profile view of another exemplary device that includes fiber attached glass.

FIG. 4 illustrates a cross sectional profile view of another exemplary device that includes fiber attached glass.

FIG. 5 illustrates a cross sectional profile view of another exemplary device that includes fiber attached glass.

FIG. 6 illustrates a cross sectional profile view of another exemplary device that includes fiber attached glass.

FIG. 7A illustrates a cross sectional profile view of another exemplary device that includes fiber attached glass.

FIG. 7B illustrates a cross sectional profile view of another exemplary device that includes fiber attached glass.

FIG. 8 illustrates stages of an exemplary sequence for fabricating an exemplary device that includes fiber attached glass.

FIG. 9 illustrates additional stages of the exemplary sequence for fabricating the exemplary device that includes fiber attached glass.

FIG. 10 illustrates an exemplary flow diagram of a method for fabricating an antenna device that includes fiber attached glass.

FIG. 11 illustrates various electronic devices that may integrate a die, an electronic circuit, an integrated device, an integrated passive device (IPD), a passive component, a package, and/or a device package described herein.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The present disclosure describes a device including a glass layer and optical fiber directly attached to the glass layer, and a photo diode electrically connected to an antenna element. The device also includes a lens coupled to or included within the glass layer and configured to manipulate light exchanged between the optical fiber and the photo diode. The photo diode is configured to convert optical signals from the optical fiber into electrical signals for the antenna element, convert electrical signals from the antenna element to optical signals provided to the optical fiber, or both. The optical fiber is directly attached to the glass layer without an alignment sleeve to align the optical fiber and a lens with a photo diode. Accordingly, a pitch between optical fibers can be reduced and a count of optical fibers and data rate supported by the device can be increased.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

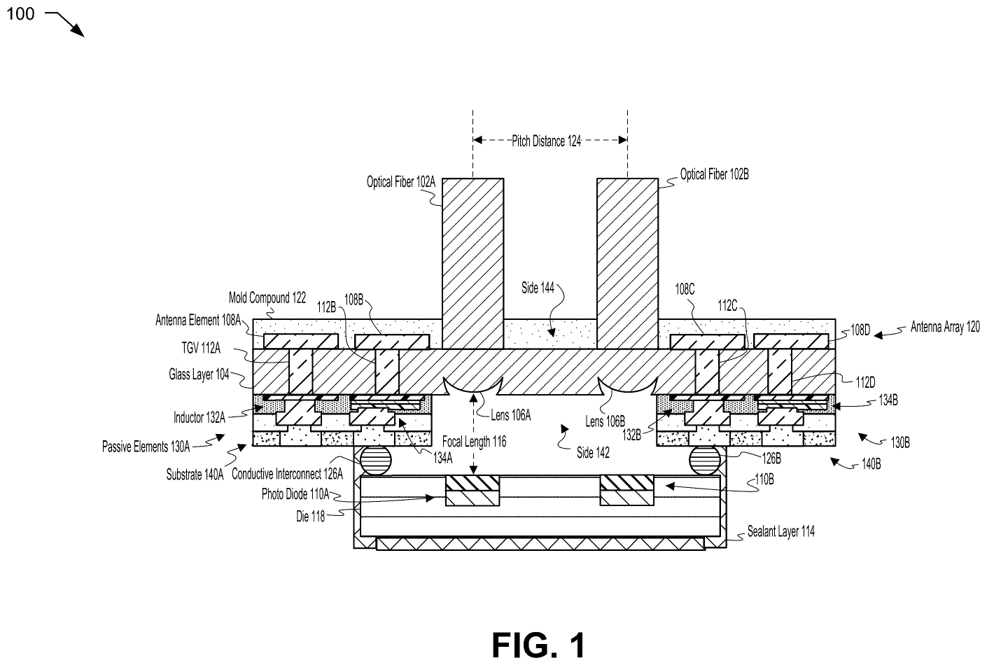

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple photo diodes are illustrated and associated with reference numbers 110A and 110B. When referring to a particular one of these locations, such as a photo diode 110A, the distinguishing letter “A” is used. However, when referring to any arbitrary one of these photo diodes or to these photo diodes as a group, the reference number 110 is used without a distinguishing letter.

As used herein, the term “layer” includes a film, and is not construed as indicating a vertical or horizontal thickness unless otherwise stated. As used herein, the term “chiplet” may refer to an integrated circuit block, a functional circuit block, or other like circuit block specifically designed to work with one or more other chiplets to form a larger, more complex chiplet architecture.

### Exemplary Antenna Devices Including Fiber Attached Glass

FIG. 1 illustrates a cross sectional profile view of a device 100 that includes fiber attached glass. The device 100 includes a glass layer 104 and a plurality of optical fibers, such as an optical fiber 102A and an optical fiber 102B, directly attached to the glass layer 104. For example, an end of the optical fiber 102A and an end of the optical fiber 102B are directly attached to a side 144 of the glass layer 104. In some aspects, an end of an optical fiber 102 is directly attached to the side 144 using fusion splicing, mechanical splicing, adhesive bonding, v-groove assembly, fiber connectors, fiber ferrules, fiber bragg gratings, or a combination thereof. In an example, an end of an optical fiber 102 is fused to the side 144 of the glass layer 104. In an example, an end of an optical fiber 102 is adhered to the side 144 of the glass layer 104. It should be understood that two optical fibers 102 directly attached to the glass layer 104 is provided as an illustrative example, in other examples more than two optical fibers 102 can be directly attached to the glass layer 104.

The device 100 also includes an antenna array 120 adjacent to the side 144 of the glass layer 104. In an example, the antenna array 120 includes an antenna element 108A, an antenna element 108B, an antenna element 108C, and an antenna element 108D. It should be understood that the antenna array 120 including four antenna elements 108 is provided as an illustrative example, in other examples the antenna array 120 can include fewer than four or more than four antenna elements. In a particular embodiment, each antenna element of the antenna array 120 is directly attached to the side 144 of the glass layer 104. In a particular embodiment, a mold compound 122 at least partially encapsulates the optical fiber 102A, the optical fiber 102B, the antenna array 120, the glass layer 104, or a combination thereof.

In a particular embodiment, there are no antenna elements 108 between the optical fiber 102A and the optical fiber 102B. For example, the antenna element 108A and the antenna element 108B are on the glass layer 104 at locations that are on a side of the optical fiber 102A opposite the optical fiber 102B. As another example, the antenna element 108C and the antenna element 108D are on the glass layer 104 at locations that are on a side of the optical fiber 102B opposite the optical fiber 102A.

The glass layer 104 is between the antenna elements 108 and a substrate 140. For example, the glass layer 104 is between the antenna elements 108A and the antenna element 108B and a substrate 140A. As another example, the glass layer 104 is between the antenna element 108C and the antenna element 108D and a substrate 140B. The substrate 140 is on a side 142 of the glass layer 104 that is opposite the side 144.

The device 100 includes passive elements 130 (e.g., passive elements 130A and passive elements 130B). The passive elements 130 include one or more inductors, capacitors, varistors, thermistors, transformers, passive filters, waveguides, or other types of passive elements. In a particular embodiment, the passive elements 130 correspond to passives-on-glass (POG) components that are coupled to the side 142.

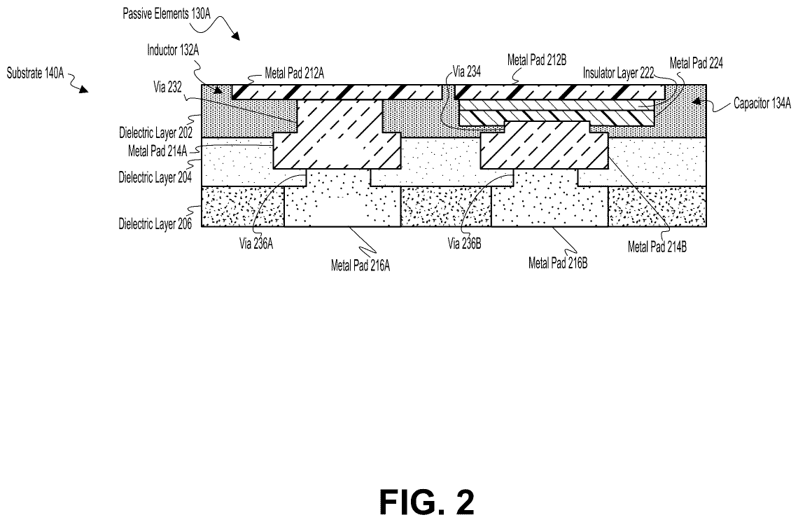

In the device 100 of FIG. 1, the passive elements 130A include an inductor 132A and a capacitor 134A, and the passive elements 130B include an inductor 132B and a capacitor 134B. In a particular embodiment, the passive elements 130 are embedded in the substrate 140 on the side 142 of the glass layer 104. For example, the passive elements 130A are embedded in the substrate 140A, as further described with reference to FIG. 2. As another example, the passive elements 130B are embedded in the substrate 140B.

It should be understood that the passive elements 130 embedded in the substrate 140A on the side 142 of the glass layer 104 is provided as an illustrative example. In other examples, one or more of the passive elements 130 can be on the side 144 of the glass layer 104, one or more of the passive elements 130 can be integrated within the glass layer 104, or both. In a particular embodiment, a passive element 130 can be integrated within the glass layer 104 including first features on the side 142 of the glass layer 104 and second features on the side 144 of the glass layer 104.

The glass layer 104 includes through-glass vias (TGVs) that electrically connect the antenna elements 108 to the passive elements 130. For example, a TGV 112A electrically connects the antenna element 108A to the inductor 132A, a TGV 112B electrically connects the antenna element 108B to the capacitor 134A, a TGV 112C electrically connects the antenna element 108C to the inductor 132B, and a TGV 112D electrically connects the antenna element 108D to the capacitor 134B.

The device 100 includes a die 118 on the side 142 of the glass layer 104. The die 118 can include integrated circuitry, such as a plurality of transistors and/or other circuit elements arranged and interconnected to form logic cells, memory cells, etc. Components of the integrated circuitry can be formed in and/or over a semiconductor substrate. Different implementations can use different types of transistors, such as a field effect transistor (FET), planar FET, finFET, a gate all around FET, or mixtures of transistor types. In some implementations, a front end of line (FEOL) process may be used to fabricate the integrated circuitry in and/or over the semiconductor substrate.

The die 118 includes a plurality of photo diodes 110, such as a photo diode 110A and a photo diode 110B. For example, the photo diode 110A and the photo diode 110B are embedded in the die 118. Each photo diode 110 is electrically connected to an antenna element 108. For example, the photo diode 110A is electrically connected, via a conductive interconnect 126A, the capacitor 134A, and the TGV 112B, to the antenna element 108B. As another example, the photo diode 110B is electrically connected, via a conductive interconnect 126B, the inductor 132B, and the TGV 112C, to the antenna element 108C. A “conductive interconnect” as used herein can include a solder bump, a solder ball, a copper bump, a copper ball, a copper post, copper coated with solder, another type of conductive interconnect, or a combination thereof.

The device 100 includes a plurality of lenses 106 coupled to or included within the glass layer 104. For example, the device 100 includes a lens 106A that is configured to manipulate light exchanged between the optical fiber 102A and the photo diode 110A. As another example, the device 100 includes a lens 106B that is configured to manipulate light exchanged between the optical fiber 102B and the photo diode 110B.

Manipulating light can include focusing, collimation, aperture control, beam shaping, correcting aberrations, increasing coupling efficiency, or a combination thereof, as non-limiting examples. In a particular embodiment, the lens 106A focuses light emitted from the optical fiber 102A to an active area of the photo diode 110A. In a particular example, the lens 106A converts diverging light from the optical fiber 102A into collimated light that reaches the photo diode 110A. In some aspects, the lens 106A with a specific aperture reduces the intensity of the light from the optical fiber 102A that reaches the photo diode 110A, reduces impact of stray or background light, or a combination thereof. In some aspects the lens 106A performs beam shaping to alter a spatial distribution of the light emitted from the optical fiber 102A. For example, the lens 106A can change a Gaussian beam profile into a flat-top profile. The lens 106A can transform the beam into a specific shape that matches a geometry of an active area of the photo diode 110A. The lens 106A can be designed to reduce optical aberrations, such as spherical aberration, chromatic aberration, and coma. The lens 106A can improve efficiency of light coupling between the optical fiber 102A and the photo diode 110A. For example, increase a portion of the light emitted from the optical fiber 102A that reaches the photo diode 110A.

Similarly, the lens 106A can manipulate light emitted from the photo diode 110A that is provided to the optical fiber 102A. In a particular embodiment, the lens 106A focuses light emitted from the photo diode 110A to a core of the optical fiber 102A. In a particular example, the lens 106A converts diverging light from the photo diode 110A into collimated light that reaches the optical fiber 102A. In some aspects the lens 106A performs beam shaping to alter a spatial distribution of the light emitted from the optical fiber 102A. For example, the lens 106A can transform the beam to match an acceptance angle and numerical aperture of the optical fiber 102A. The lens 106A can reduce optical aberrations in the light that reaches the optical fiber 102A. The lens 106A can increase a portion of the light emitted from the photo diode 110A that reaches the optical fiber 102A.

It should be understood that the glass layer 104 is provided as an illustrative example of a material that is directly attached to the optical fibers 102, in some examples another material that is rigid, transparent to the frequency of light exchanged between the optical fibers 102 and the photo diodes 110, and non-conductive can be used to directly attach the optical fibers 102. For example, the optical fibers 102 can be directly attached to a polymer layer.

A sealant layer 114 encapsulates the conductive interconnect 126A, the die 118, and the conductive interconnect 126B. The sealant layer 114 encapsulates a volume (which may be evacuated (e.g., vacuum) or may be filled with a gas) that includes the lenses 106 and the photo diodes 110. In a particular aspect, the sealant layer 114 keeps particles (e.g., dust) from entering the encapsulated volume and interfering in the light exchanged between the lenses 106 and the photo diodes 110.

A distance between the lens 106A and the photo diode 110A corresponds to a focal length 116 of the lens 106A. In some examples, the lens 106A and the photo diode 110A are positioned to have a particular distance that is based on a pre-determined focal length 116 of the lens 106A. In some examples, the lens 106A is designed to have the focal length 116 based on a target distance between the lens 106A and the photo diode 110A.

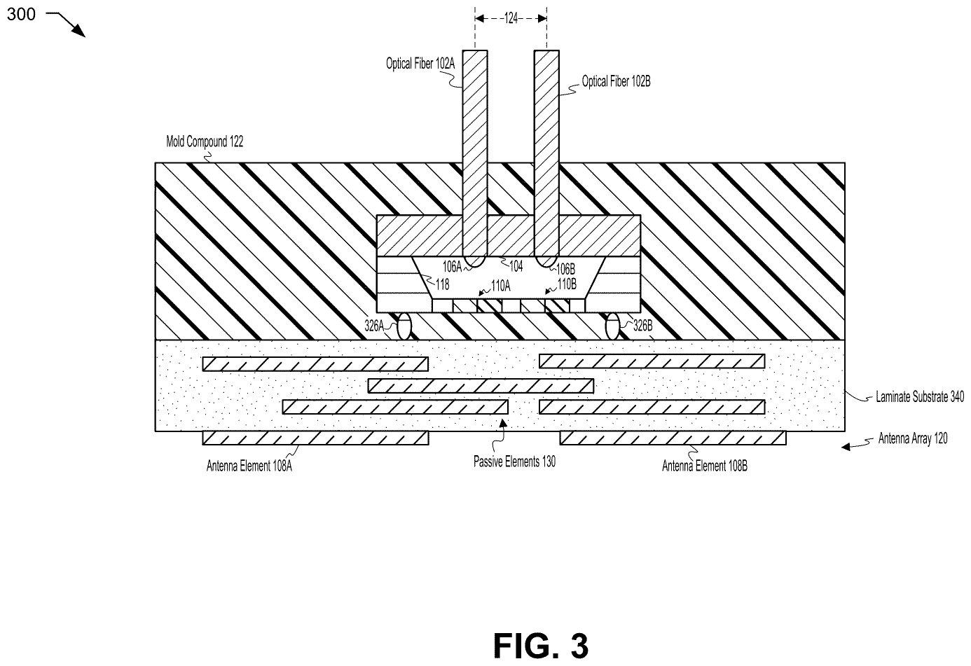

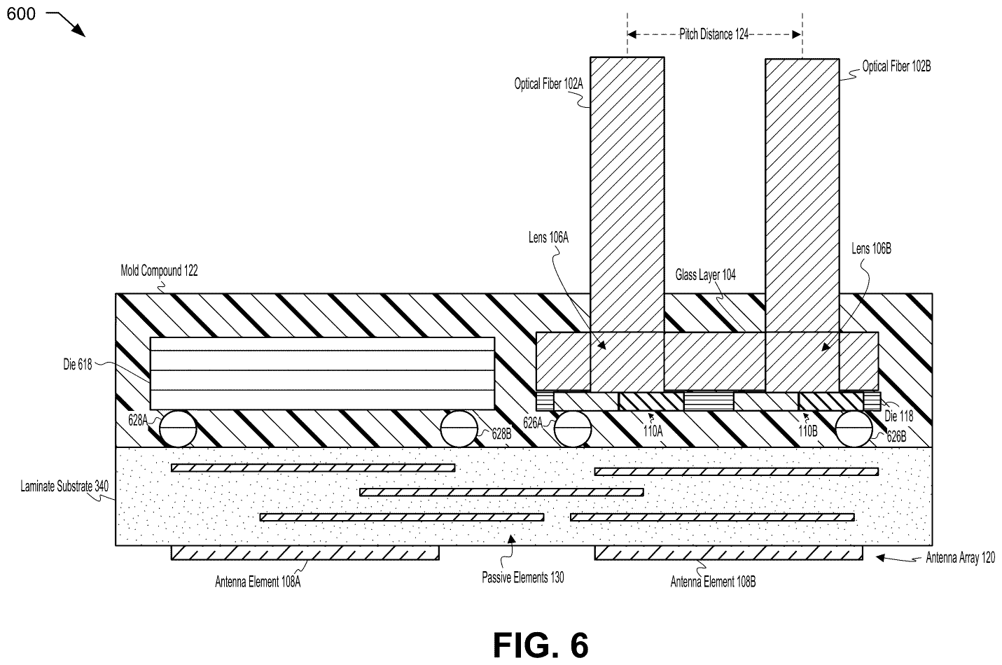

In the device 100 of FIG. 1, the lens 106A and the lens 106B are illustrated as shaped portions of the glass layer 104. In other examples, a lens 106 can be directly attached (e.g., adhered or fused) to the side 142 of the glass layer 104, as described with reference to FIG. 3. In yet other examples, a lens 106 corresponds to a gradient index lens included within the glass layer 104, as described with reference to FIG. 6.

The optical fibers 102 are directly attached to the side 144 of the glass layer 104 and the photo diodes 110 are on the side 142 of the glass layer 104. The photo diode 110A is configured to convert optical signals from the optical fiber 102A into electrical signals for the antenna element 108B, convert electrical signals from the antenna element 108B to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the conductive interconnect 126A, the capacitor 134A, and the TGV 112B, to the antenna element 108B for wireless transmission. In another example, electrical signals received by the antenna element 108B are provided through the TGV 112B, the capacitor 134A, and the conductive interconnect 126A to the photo diode 110A, and the photo diode 110A converts the electrical signals to optical signals that pass through the lens 106A to the optical fiber 102A for fiber-optic transmission. Similarly, the photo diode 110B is configured to convert optical signals from the optical fiber 102B into electrical signals for the antenna element 108C, convert electrical signals from the antenna element 108C to optical signals provided to the optical fiber 102B, or both.

In a particular embodiment, a pitch distance 124 between a center of a first connection of the optical fiber 102A to the glass layer 104 and a center of a second connection of the optical fiber 102B to the glass layer 104 is less than 0.2 millimeters (mm). Having the optical fibers 102 directly attached to the glass layer 104 enables the pitch distance 124 (e.g., 0.2 mm) to be less than a pitch distance (e.g., 2 mm) associated with using alignment sleeves to align the optical fibers to photo diodes of a device. A lower pitch distance enables more optical fibers to be supported by the device 100, enables a smaller device to provide a target data rate, or both.

The techniques described herein are scalable to support beyond 6th generation (6G) wireless. For example, the device 100 can include more than two optical fibers 102 directly attached to the glass layer 104. In an example, the device 100 can be a modular antenna device component that can be combined with other similar devices. In a particular embodiment, the device 100 is used in a first fiber array (e.g., 12×12 optical fibers) that supports a first fiber bundle (e.g., 144 optical fiber bundle) having first dimensions (e.g., 2.5×2.5 mm²). In another embodiment, the device 100 is used in a second fiber array (e.g., 30×30 optical fibers) that supports a second fiber bundle (e.g., 900 optical fiber bundle) having second dimensions (e.g., 6×6 mm²). Smaller antenna devices with lower manufacturing costs can be more affordable to have one in each room to improve network connectivity.

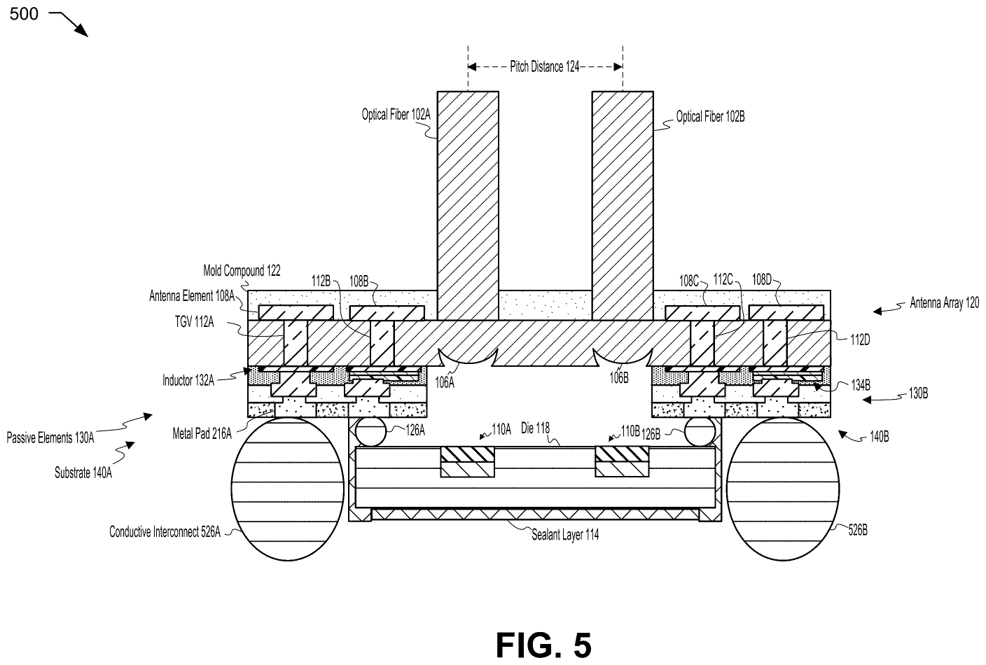

In some implementations, the die 118 includes input/output (I/O) circuitry, and one or more of the passive elements 130 are connected to the I/O circuitry to provide a data path between the die 118 and another device, as further described with reference to FIGS. 5 and 6. As one illustrative example, the other device can include a Dynamic Random-Access Memory (DRAM) chip (or chiplet). In this illustrative example, the I/O circuitry of the die 118 can include or correspond to interface circuitry (e.g., serializer/deserializer (SerDes) circuitry, a double data rate (DDR)-type DRAM bus interface circuit), memory buffers, and/or other circuitry that facilitates interaction between active circuitry of the die 118 and the DRAM.

The device 100 can also include connectors to couple the device 100 to other circuitry of the device 100. For example, the device 100 can include interconnects, such as ball grid array (BGA), C4 bumps, or other connectors to electrically couple the device 100 to a substrate. In this example, the interconnects can include connectors to a second set of contacts of a second die.

FIG. 2 illustrates a cross sectional profile view of one example of the substrate 140A with embedded passive elements 130A of FIG. 1. The substrate 140A includes a dielectric layer 202 (e.g., a top layer) and a dielectric layer 206 (e.g., a bottom layer).

The dielectric layer 202 is configured to be adjacent to the side 142 of the glass layer 104. A plurality of metal pads 212, such as a metal pad 212A and a metal pad 212B, are embedded in the dielectric layer 202. In a particular aspect, the metal pad 212A is positioned to align with the TGV 112A of FIG. 1 to electrically connect to the antenna element 108A, and the metal pad 212B is positioned to align with the TGV 112B to electrically connect to the antenna element 108B.

A plurality of metal pads 216, such as a metal pad 216A and a metal pad 216B, are embedded in the dielectric layer 206. In a particular aspect, the metal pad 216B is positioned to align with the conductive interconnect 126A of FIG. 1 to electrically connect to the die 118 and one or more photo diodes, such as the photo diode 110A, embedded in the die 118.

The substrate 140 includes one or more intermediate dielectric layers, such as a dielectric layer 204, between the dielectric layer 202 and the dielectric layer 206. Metal pads, vias, insulator layers, or a combination thereof, are embedded in the one or more intermediate dielectric layers. In an example, the substrate 140A includes a via 232, a metal pad 214A, and a via 236A that are arranged to electrically interconnect the metal pad 212A and the metal pad 216A. In some embodiments, two or more of the metal pad 212A, the via 232, the metal pad 214A, the via 236A, or the metal pad 216A are offset and interconnected using electrical traces. In a particular aspect, the via 232 is embedded in the dielectric layer 202 and the via 236A is embedded in the dielectric layer 204. In another example, the substrate 140A includes an insulator layer 222, a metal pad 224, a via 234, and a metal pad 214B aligned with and between the metal pad 212B and the metal pad 216B. In a particular aspect, the insulator layer 222, the metal pad 224, and the via 234 are embedded in the dielectric layer 202. The via 236B is embedded in the dielectric layer 204.

The passive elements 130A (e.g., the inductor 132A and the capacitor 134A) are embedded in the substrate 140A. In some embodiments, the inductor 132A is a two-dimensional (2D) inductor that includes the metal pad 212A. In some embodiments, the inductor 132A is a three dimensional (3D) inductor that includes the metal pad 212A, the via 232, the metal pad 214A, the via 236A, and the metal pad 216A. In some embodiments, the capacitor 134A includes the metal pad 212B, the insulator layer 222, and the metal pad 224. In a particular aspect, the substrate 140B corresponds to a mirror image of the substrate 140A.

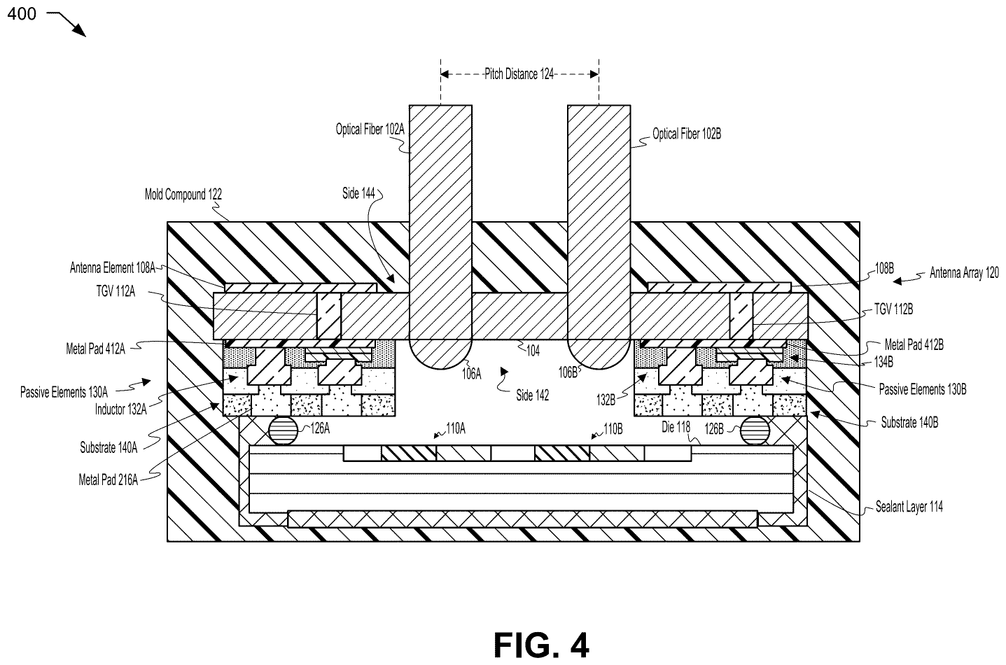

In an alternative embodiment, the inductor 132A and the capacitor 134A share a common metal pad (e.g., a metal pad 212). For example, an LC circuit includes the inductor 132A and the capacitor 134A, as further described with reference to FIG. 4.

FIG. 3 illustrates a cross sectional profile view of a device 300 that includes fiber attached glass. The device 300 includes the optical fibers 102 directly attached to the glass layer 104. For example, the optical fiber 102A extends through the glass layer 104 and the optical fiber 102B extends through the glass layer 104.

The device 300 includes lenses 106 attached (e.g., fused or adhered) to the optical fibers 102. For example, the lens 106A is attached to the optical fiber 102A and the lens 106B is attached to the optical fiber 102B. In an alternative embodiment, the optical fibers 102 are directly attached to the glass layer 104 and the lenses 106 are on the glass layer 104, as described with reference to FIG. 1.

The photo diode 110A is aligned with the lens 106A and the optical fiber 102A. The photo diode 110B is aligned with the lens 106B and the optical fiber 102B. The die 118 encapsulates a volume (e.g., vacuum or gas filled) that includes the photo diodes 110 and the lenses 106.

The device 300 includes a laminate substrate 340 that is between the photo diodes 110 and the antenna elements 108 of the antenna array 120. For example, the antenna element 108A and the antenna element 108B are adjacent to a first side of the laminate substrate 340 and the die 118 is on a second side of the laminate substrate 340 that is opposite the first side. In a particular aspect, the antenna elements 108 are coupled to or embedded in the first side of the laminate substrate 340. In contrast to FIG. 1 where the antenna array 120 and the optical fibers 102 are coupled to the glass layer 104 and disposed on the same side 144 of the glass layer 104, in FIG. 3 the antenna array 120 is separate from the glass layer 104 and on the opposite side from the optical fibers 102. In a particular aspect, the one or more passive elements 130 are coupled to or embedded within the laminate substrate 340. The die 118 is electrically connected via a plurality of conductive interconnects 326 (e.g., a conductive interconnect 326A and a conductive interconnect 326B) and the passive elements 130 to the antenna elements 108.

The photo diode 110A is configured to convert optical signals from the optical fiber 102A into electrical signals for the antenna element 108A, convert electrical signals from the antenna element 108A to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the die 118, the conductive interconnect 326A, and one or more of the passive elements 130 to the antenna element 108A for wireless transmission. In another example, electrical signals received by the antenna element 108A are provided through one or more of the passive elements 130, the conductive interconnect 326A, and the die 118 to the photo diode 110A, and the photo diode 110A converts the electrical signals to optical signals that pass through the lens 106A to the optical fiber 102A for fiber-optic transmission. Similarly, the photo diode 110B is configured to convert optical signals from the optical fiber 102B into electrical signals for the antenna element 108B, convert electrical signals from the antenna element 108B to optical signals provided to the optical fiber 102B, or both.

The mold compound 122 at least partially encapsulates the optical fibers 102, the glass layer 104, the die 118, the lenses 106, the photo diodes 110, the conductive interconnect 326A, the conductive interconnect 326B, or a combination thereof. Details of the passive elements 130 are not shown for ease of illustration. It should be understood that the conductive interconnect 326A and the conductive interconnect 326B are provided as an illustrative example of contacts, in other examples contacts of a different shape, a different material, or both, can be used.

FIG. 4 illustrates a cross sectional profile view of a device 400 that includes fiber attached glass. The device 400 includes the optical fibers 102 directly attached to the glass layer 104 and lenses 106 attached (e.g., fused or adhered) to the optical fibers 102, as described with reference to FIG. 3. In an alternative embodiment, the optical fibers 102 are directly attached to the glass layer 104 and the lenses 106 are on or in the glass layer 104, as described with reference to FIG. 1.

The antenna elements 108 of the antenna array 120 are adjacent to the side 144 of the glass layer 104. For example, the antenna element 108A and the antenna element 108B are adjacent to the side 144. A plurality of TGVs extend through the glass layer 104 to electrically connect the antenna elements 108 on the side 144 to metal pads 412 of a substrate 140 on the side 142 of the glass layer 104. For example, a TGV 112A extends through the glass layer 104 and electrically connects the antenna element 108A to a metal pad 412A of a substrate 140A. As another example, a TGV 112B extends through the glass layer 104 and electrically connects the antenna element 108B to a metal pad 412B of a substrate 140B.

In FIG. 4, the substrate 140A differs from the substrate 140A of FIG. 1 in that the inductor 132A and the capacitor 134A share a common metal pad (e.g., the metal pad 412A). For example, a first LC circuit includes the inductor 132A and the capacitor 134A. Similarly, the inductor 132B and the capacitor 134B share a common metal pad (e.g., the metal pad 412B). For example, a second LC circuit includes the inductor 132B and the capacitor 134B.

The die 118 is electrically connected via a plurality of conductive interconnects 126 (e.g., a conductive interconnect 126A and a conductive interconnect 126B) and the passive elements 130 to the antenna elements 108. For example, the conductive interconnect 126A is aligned with the metal pad 216A to electrically connect the inductor 132A to the die 118. As another example, the conductive interconnect 126B is aligned with a metal pad of the capacitor 134B to electrically connect the capacitor 134B to the die 118.

The photo diode 110A is aligned with the lens 106A and the optical fiber 102A. The photo diode 110B is aligned with the lens 106B and the optical fiber 102B. The sealant layer 114 encapsulates a volume (e.g., vacuum or gas filled) that includes the photo diodes 110 and the lenses 106.

The photo diode 110A is configured to convert optical signals from the optical fiber 102A into electrical signals for the antenna element 108A, convert electrical signals from the antenna element 108A to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the die 118, the conductive interconnect 126A, one or more of the passive elements 130A, and the TGV 112A to the antenna element 108A for wireless transmission. In another example, electrical signals received by the antenna element 108A are provided through the TGV 112A, one or more of the passive elements 130A, the conductive interconnect 126A, and the die 118 to the photo diode 110A, and the photo diode 110A converts the electrical signals to optical signals that pass through the lens 106A to the optical fiber 102A for fiber-optic transmission. Similarly, the photo diode 110B is configured to convert optical signals from the optical fiber 102B into electrical signals for the antenna element 108B, convert electrical signals from the antenna element 108B to optical signals provided to the optical fiber 102B, or both.

The mold compound 122 at least partially encapsulates the optical fibers 102, the antenna array 120, the glass layer 104, the passive elements 130, the conductive interconnect 126A, the conductive interconnect 126B, the die 118, the sealant layer 114, the lenses 106, the photo diodes 110, or a combination thereof.

FIG. 5 illustrates a cross sectional profile view of a device 500 that includes fiber attached glass. The device 500 corresponds to the device 100 of FIG. 1 and also includes a plurality of conductive interconnects 526 electrically connected to the passive elements 130.

In an example, a conductive interconnect 526A is directly attached to the metal pad 216A and electrically connected to the inductor 132A. In another example, a conductive interconnect 526B is directly attached to a metal pad of the substrate 140B and electrically connected to the capacitor 134B.

The conductive interconnects 526 can be used to electrically connect the antenna elements 108 to a second die, a second device, or both. For example, the antenna element 108A is electrically connected via the TGV 112A, the inductor 132A, one or more metal pads, one or more vias, the metal pad 216A, or a combination thereof, to the conductive interconnect 526A. As another example, the antenna element 108D is electrically connected via the TGV 112D, the capacitor 134B, one or more metal pads, one or more vias, or a combination thereof, to the conductive interconnect 526B.

FIG. 6 illustrates a cross sectional profile view of a device 600 that includes fiber attached glass. The device 600 includes the optical fibers 102 directly attached to the glass layer 104. The device 600 includes lenses 106 that correspond to gradient index lenses included within the glass layer 104. For example, the lens 106A corresponds to a first gradient index portion of the glass layer 104 that is aligned with a first connection of the optical fiber 102A with the glass layer 104 and the lens 106B corresponds to a second gradient index portion of the glass layer 104 that is aligned with a second connection of the optical fiber 102B with the glass layer 104. In an alternative embodiment, the lenses 106 are on the glass layer 104, as described with reference to FIG. 1.

A plurality of photo diodes 110 are embedded in the die 118. A photo diode 110A is aligned with the lens 106A and is adjacent to the side 142 of the glass layer 104. For example, the photo diode 110A is directly attached to the lens 106A. Similarly, a photo diode 110B is aligned with the lens 106B and is adjacent to the side 142 of the glass layer 104. For example, the photo diode 110B is directly attached to the lens 106B.

The device 600 includes a laminate substrate 340 that is between the photo diodes 110 and antenna elements 108 of an antenna array 120. For example, an antenna element 108A and an antenna element 108B are adjacent to a first side of the laminate substrate 340 and the die 118 is on a second side of the laminate substrate 340 that is opposite the first side. In a particular aspect, the antenna elements 108 are adhered to or embedded in the first side of the laminate substrate 340. The antenna elements 108 of the antenna array 120 are on the side 142 of the glass layer 104 that is opposite the side 144. In a particular aspect, one or more passive elements 130 are coupled to or embedded within the laminate substrate 340.

The die 118 is electrically connected via a plurality of conductive interconnects 626 (e.g., a conductive interconnect 626A and a conductive interconnect 626B) and one or more of the passive elements 130 to the antenna elements 108. The conductive interconnects 626 are directly attached to the photo diodes 110. For example, a conductive interconnect 626A is directly attached to the photo diode 110A and to one or more of the passive elements 130. As another example, a conductive interconnect 626B is directly attached to the photo diode 110B and to one or more of the passive elements 130.

The photo diode 110A is configured to convert optical signals from the optical fiber 102A into electrical signals for the antenna element 108A, convert electrical signals from the antenna element 108A to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the conductive interconnect 626A and one or more of the passive elements 130 to the antenna element 108A for wireless transmission. In another example, electrical signals received by the antenna element 108A are provided through one or more of the passive elements 130 and the conductive interconnect 626A to the photo diode 110A, and the photo diode 110A converts the electrical signals to optical signals that pass through the lens 106A to the optical fiber 102A for fiber-optic transmission. In another example, the photo diode 110B is configured to convert optical signals from the optical fiber 102B into electrical signals for the antenna element 108B, convert electrical signals from the antenna element 108B to optical signals provided to the optical fiber 102B, or both.

The device 600 includes one or more additional dies, such as a die 618, coupled to the die 118 via the laminate substrate 340. Active circuitry of the die 618 is not provided for ease of illustration. In a particular aspect, the die 618 includes a transmitter, a receiver, a transceiver, a low-noise amplifier, a power amplifier, a passive device, or a combination thereof. In a particular embodiment, the die 618 can correspond to another one of a die 118, as described herein. For example, photo diodes can be embedded in the die 618 and the die 618 can be attached or adjacent to a glass layer that has directly attached optical fibers.

The die 618 is electrically connected via a plurality of conductive interconnects 628 (e.g., a conductive interconnect 628A and a conductive interconnect 628B) and one or more of the passive elements 130 to one or more of the antenna elements 108, the die 118, or a combination thereof. In an example, electrical signals can be exchanged between one or more of the antenna elements 108 and the die 618. In an example, electrical signals can be exchanged between one or more of the photo diodes 110 and the die 618.

The mold compound 122 at least partially encapsulates the optical fibers 102, the glass layer 104, the die 118, the lenses 106, the photo diodes 110, the conductive interconnect 626A, the conductive interconnect 626B, the die 618, the conductive interconnect 628A, the conductive interconnect 628B, or a combination thereof. The laminate substrate 340 is adjacent to a first side of the mold compound 122. Details of the passive elements 130 are not shown for ease of illustration. It should be understood that the conductive interconnect 626A, the conductive interconnect 626B, the conductive interconnect 628A, and the conductive interconnect 628B are provided as an illustrative example of contacts, in other examples contacts of a different shape, a different material, or both, can be used.

In a particular embodiment, the die 118, the die 618, or both, correspond to chiplets. Forming the device 600 using chiplets arranged and interconnected as a 3D stacked integrated circuit (IC) can provide various benefits as compared to providing the same functional circuitry in one monolithic chip. For example, each chiplet is smaller than a monolithic die including all of the same functional circuit blocks would be. Since yield loss in IC manufacturing tends to increase as the die size increases, using smaller dies can reduce yield loss (i.e., increase yield) of the IC manufacturing process. Another benefit is that the chiplets can be fabricated in different locations and/or by different manufacturers, and in some cases, using different fabrication technologies (e.g., different fabrication technology nodes). As an example, one die of a chiplet-based integrated device (e.g., the die 118) can include components (e.g., interconnects, transistors, etc.) that have a first minimum size, and another die of the chiplet-based integrated device (e.g., the die 618) can include components (e.g., interconnects, transistors, etc.) that have a second minimum size, where the second minimum size is greater than the first minimum size. In contrast, all of the circuitry of a monolithic die is fabricated using the same fabrication technologies and equipment. As a result, when manufacturing a monolithic die, the entire die may be subject to the tightest manufacturing constraint of the most complex component of the monolithic die. In contrast, when using chiplets, different chiplets can be manufactured using different fabrication technologies (e.g., different fabrication technology nodes), and only the chiplet or chiplets that include the most complex components are subjected to the tightest manufacturing constraints. In this arrangement, chiplets fabricated using less expensive and/or higher yield fabrication technologies can be integrated with chiplets fabricated using more expensive and/or lower yield fabrication technologies to form an IC (e.g., the device 600), resulting in overall savings. Still further, in some cases, as technology improves, the design of a chiplet can be changed. Chiplet stacking allows such new chiplet designs to be integrated with older chiplet designs to form stacked IC devices, which improves manufacturing flexibility and reduces design costs.

Although FIG. 6 illustrates the device 600 as including two dies (e.g., the die 118 and the die 618) in some implementations, the device 600 includes more than two dies stacked and interconnected to form a 3D IC stack. In such implementations, one or more additional dies can have photo diodes aligned with lenses that are on or in a glass layer with attached optical fibers and the photo diodes configured to exchange electrical signals with antenna elements.

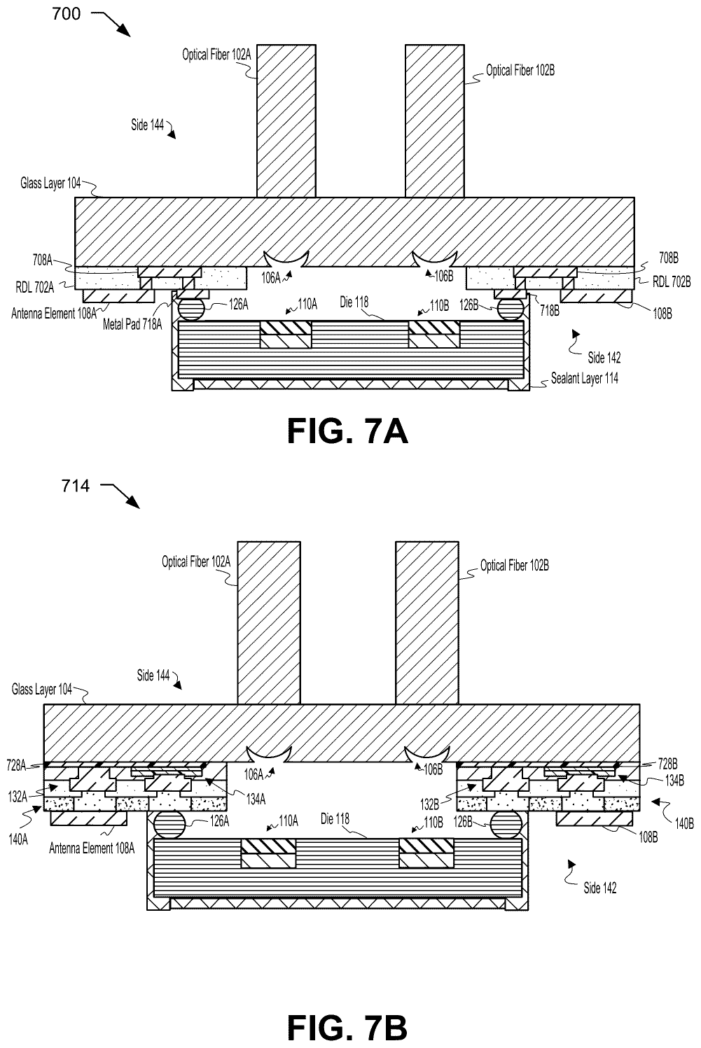

FIG. 7A illustrates a cross sectional profile view of a device 700 that includes fiber attached glass. The device 700 includes optical fibers 102 directly attached to a side 144 of a glass layer 104, and lenses 106 on or within the glass layer 104, and a plurality of photo diodes 110 that are embedded in a die 118, as described with reference to FIG. 1.

The device 700 includes an antenna array 120 and passive elements 130 on a side 142 of the glass layer 104 that is opposite the side 144. In an example, a redistribution layer (RDL) 702 is adjacent to the side 142 and electrically connects the antenna array 120 to the photo diodes 110 of the die 118. In a particular aspect, one or more metal pads 708 and one or more vias are embedded in the RDL 702. In a particular aspect, the RDL 702, the metal pads 708, and the one or more vias correspond to the passive elements 130.

In an example, an antenna element 108A is electrically connected through a RDL 702A to a conductive interconnect 126A. To illustrate, the antenna element 108A is electrically connected through a via to a metal pad 708A and the metal pad 708A is electrically connected through a via and a metal pad 718A to the conductive interconnect 126A. In another example, the antenna element 108B is electrically connected through a RDL 702B to a conductive interconnect 126B. To illustrate, the antenna element 108B is electrically connected through a via to a metal pad 708B and the metal pad 708B is electrically connected through a via and a metal pad 718B to the conductive interconnect 126B. The conductive interconnects 126A and 126B are attached to the die 118, as described with reference to FIG. 1.

The photo diode 110A is configured to convert optical signals from the optical fiber 102A into electrical signals for the antenna element 108A, convert electrical signals from the antenna element 108A to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the conductive interconnect 126A, the metal pad 718A, and a via to the metal pad 708A. The metal pad 708A provides the electrical signals through a via to the antenna element 108A for wireless transmission. In another example, electrical signals received by the antenna element 108A are provided through a via to the metal pad 708A. The metal pad 708A provides the electrical signals through a via, the metal pad 718A, and the conductive interconnect 126A to the photo diode 110A. The photo diode 110A converts the electrical signals to optical signals that pass through the lens 106A to the optical fiber 102A for fiber-optic transmission.

Similarly, the photo diode 110B is configured to convert optical signals from the optical fiber 102B into electrical signals for the antenna element 108B, convert electrical signals from the antenna element 108B to optical signals provided to the optical fiber 102B, or both. To illustrate, optical signals from the optical fiber 102B pass through the lens 106B to the photo diode 110B, and the photo diode 110B converts the optical signals to electrical signals and provides the electrical signals through the conductive interconnect 126B, the metal pad 718B, and a via to the metal pad 708B. The metal pad 708B provides the electrical signals through a via to the antenna element 108B for wireless transmission. In another example, electrical signals received by the antenna element 108B are provided through a via to the metal pad 708B. The metal pad 708B provides the electrical signals through a via, the metal pad 718B, and the conductive interconnect 126B to the photo diode 110B. The photo diode 110B converts the electrical signals to optical signals that pass through the lens 106B to the optical fiber 102B for fiber-optic transmission.

A sealant layer 114 at least partially encapsulates the die 118, the lenses 106, the photo diodes 110, the conductive interconnect 126A, the conductive interconnect 126B, the metal pad 718A, the metal pad 718B, or a combination thereof. It should be understood that the conductive interconnect 126A and the conductive interconnect 126B are provided as an illustrative example of contacts, in other examples contacts of a different shape, a different material, or both, can be used.

FIG. 7B illustrates a cross sectional profile view of a device 714 that includes fiber attached glass. The device 714 corresponds to the device 700 and includes one or more inductors, one or more capacitors, or a combination thereof, as the passive elements 130 in a substrate 140.

In an example, a substrate 140A includes an inductor 132A and a capacitor 134A embedded in a plurality of dielectric layers. The substrate 140A also includes a metal pad 728A electrically connecting the inductor 132A to the capacitor 134A. As another example, a substrate 140B includes an inductor 132B and a capacitor 134B embedded in a plurality of dielectric layers. The substrate 140B also includes a metal pad 728B electrically connecting the inductor 132B to the capacitor 134B.

The substrate 140 is between the glass layer 104 and the antenna array 120 and the antenna array 120 is on the same side of the substrate 140 as the die 118. The substrate 140A and the substrate 140B are adjacent to the side 142 of the glass layer 104. In a particular embodiment, the metal pad 728A and the metal pad 728B are adjacent to the side 142.

The antenna element 108A is adjacent to the substrate 140A and electrically connected through the inductor 132A, the metal pad 728A, and the capacitor 134A to the conductive interconnect 126A. Similarly, the antenna element 108B is adjacent to the substrate 140B and electrically connected through the capacitor 134B, the metal pad 728B, and the inductor 132B to the conductive interconnect 126B. The conductive interconnects 126A and 126B are attached to the die 118, as described with reference to FIG. 1.

The photo diode 110A is configured to convert optical signals from the optical fiber 102A into electrical signals for the antenna element 108A, convert electrical signals from the antenna element 108A to optical signals provided to the optical fiber 102A, or both. In an example, optical signals from the optical fiber 102A pass through the lens 106A to the photo diode 110A, and the photo diode 110A converts the optical signals to electrical signals and provides the electrical signals through the conductive interconnect 126A, the capacitor 134A, the metal pad 728A, and the inductor 132A to the antenna element 108A for wireless transmission. In another example, electrical signals received by the antenna element 108A are provided through the inductor 132A, the metal pad 728A, the capacitor 134A, and the conductive interconnect 126A to the photo diode 110A. The photo diode 110A converts the electrical signals to optical signals that pass through the lens 106A to the optical fiber 102A for fiber-optic transmission. Similarly, the photo diode 110B is configured to convert optical signals from the optical fiber 102B into electrical signals for the antenna element 108B, convert electrical signals from the antenna element 108B to optical signals provided to the optical fiber 102B, or both.

A sealant layer 114 at least partially encapsulates the die 118, the lenses 106, the photo diodes 110, the conductive interconnect 126A, the conductive interconnect 126B, the capacitor 134A, the inductor 132B or a combination thereof. It should be understood that the conductive interconnect 126A and the conductive interconnect 126B are provided as an illustrative example of contacts, in other examples contacts of a different shape, a different material, or both, can be used.

FIGS. 1-7B provide some non-limiting illustrative examples of antenna devices that include fiber attached glass. In other examples, there are different types of lenses 106, various ways to attach the optical fibers 102, different locations for the antenna array 120, various ways to provide electrical connections from an antenna device to another device, various ways to control focal length, different locations for the passive elements 130, etc. As an example, lenses 106 can be fused to, adhered to, or included in (e.g., as gradient index lenses) a glass layer 104. Optical fibers 102 can be attached to a surface of or extend through the glass layer 104. The antenna elements 108 can be on the same side or on an opposite side from the optical fibers 102. The antenna elements 108 can be adjacent to or separate from the glass layer 104. The antenna elements 108 can be adjacent to a laminate substrate 340. The glass layer 104 can be replaced with a layer of another material that is rigid, non-conductive, and transparent to a light frequency used. Different types of passive elements 130 can be included in a device at various locations. Various techniques disclosed herein can be combined in various ways to form antenna devices.

### Exemplary Sequence for Fabricating an Antenna Device Including Fiber Attached Glass

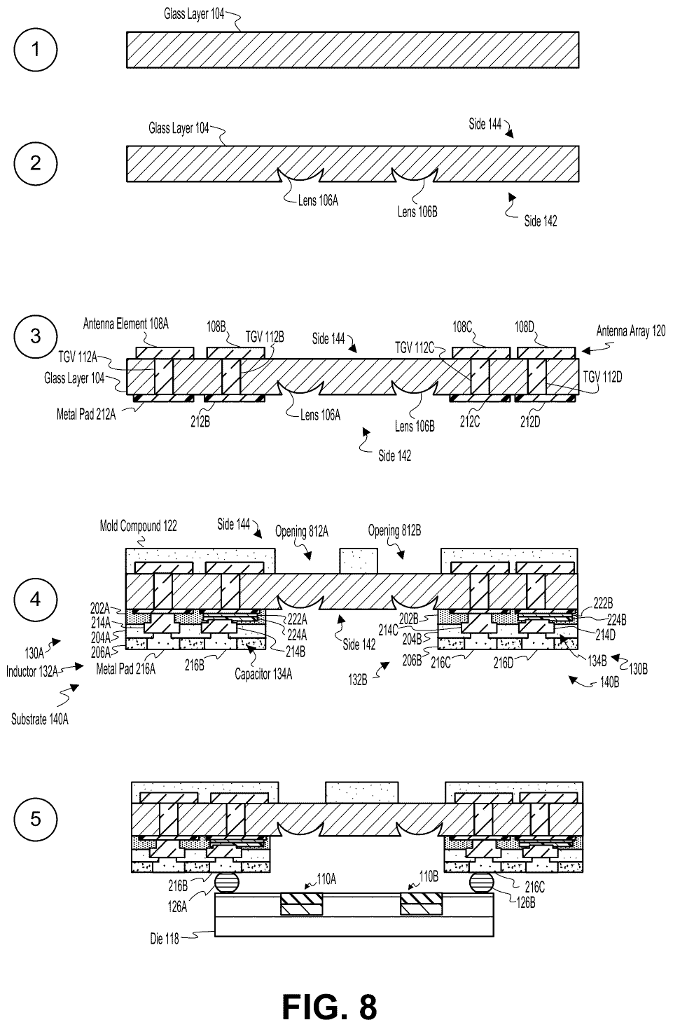

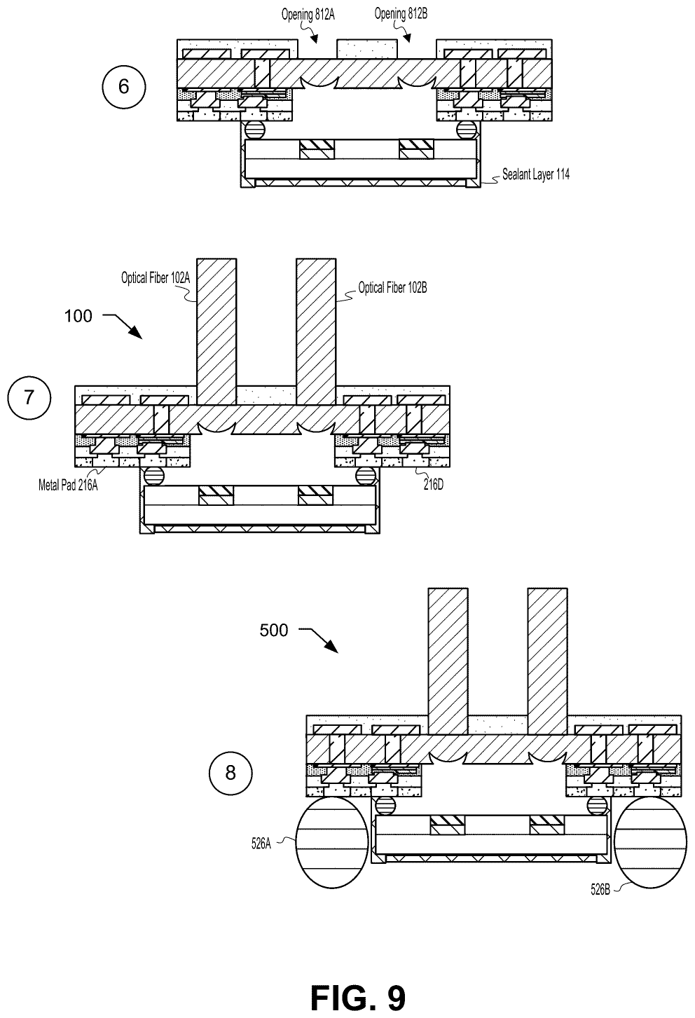

In some implementations, fabricating an antenna device (e.g., any of the devices 100, 300, 400, 500, 600, 700, or 714) includes several processes. FIGS. 8-9 illustrate an exemplary sequence for providing or fabricating an antenna device including fiber attached glass, as described with reference to any of FIGS. 1-7B. In some implementations, the sequence of FIGS. 8-9 may be used to provide (e.g., during fabrication of) one or more of the devices 100, 300, 400, 500, 600, 700, or 714 of FIGS. 1-7.

It should be noted that the sequence of FIGS. 8-9 may combine one or more stages in order to simplify and/or clarify the sequence for providing or fabricating an integrated device. In some implementations, the order of the processes may be changed or modified. In some implementations, one or more of the processes may be replaced or substituted without departing from the scope of the disclosure. In the following description, reference is made to various illustrative Stages of the sequence, which are numbered (using circled numbers) in FIGS. 8-9. Each of the various stages of the sequence illustrated in FIGS. 8-9 shows formation of a device with two optical fibers. In other implementations, a device can be formed with more than two optical fibers.

Stage 1 of FIG. 8 illustrates a glass layer 104. Stage 2 illustrates a state after formation of a plurality of lenses 106 on a side 142 of the glass layer 104. In a particular implementation, a first portion of the glass layer 104 is shaped (e.g., etched) to form a lens 106A and a second portion of the glass layer 104 is shaped (e.g., etched) to form a lens 106B. In another embodiment, a first portion of the glass layer 104 includes a gradient index lens as the lens 106A and a second portion of the glass layer 104 includes a gradient index lens as the lens 106B. For example, various gradient index (GRIN) lens formation techniques (e.g., neutron irradiation, chemical vapor deposition, ion exchange, or a combination thereof) are used to form the lens 106A and the lens 106B. In a particular aspect, selective doping based on ion implantation is used to form the lens 106A and the lens 106B in the glass layer 104. In yet another embodiment, a lens 106A is attached (e.g., fused or adhered) to a first portion of the glass layer 104 and a lens 106B is attached (e.g., fused or adhered) to a second portion of the glass layer 104. In some examples, the lens 106A and the lens 106B are attached to the glass layer 104 at a later stage of fabrication, such as after Stage 3 or Stage 4.

In some examples, the lens 106A and the lens 106B are covered (e.g., with a polymer or photo resist) to protect from contaminants during subsequent fabrication stages and the cover is removed after a later Stage. In some aspects, the cover on the lenses 106 can get removed as part of a subsequent fabrication Stage and have to be reapplied to protect the lenses 106 during fabrication. Formation of the lenses on the glass layer can be performed using wafer level or panel level operations.

Stage 3 illustrates a state after a plurality of through-glass vias (TGVs) 112, antenna elements 108, and metal pads 212 are formed on the glass layer 104. For example, openings are formed in the glass layer 104 and filled with a conductive material to form a TGV 112A, a TGV 112B, a TGV 112C, and a TGV 112D. The openings can be formed using patterning operations, etching processes, drilling operations, laser ablation operations, other targeted glass removal operations, or combinations thereof.

One or more patterned metal deposition processes (such as plating) are used to deposit a first metal layer on the side 144 of the glass layer 104 and a second metal layer on the side 142 of the glass layer 104. In some aspects, the same material is deposited on the side 142 and the side 144 to form the first metal layer and the second metal layer. In alternative aspects, the first metal layer includes a first metal that is not included in the second metal layer, the second metal layer includes a second metal that is not included in the first metal layer, or both.

In some examples, the metal layers are deposited and subsequently patterned, and in other examples, a patterning layer (e.g., a photoresist layer) is applied to the glass layer 104 and used to guide formation of the metal layers. In a particular aspect, the antenna elements 108A-D are formed (e.g., from the first metal layer) on the side 144 of the glass layer 104 and a metal pad 212A, a metal pad 212B, a metal pad 212C, and a metal pad 212D are formed (e.g., from the second metal layer) on the side 142 of the glass layer 104. In a particular implementation, each pair of antenna element and metal pad is electrically connected. For example, the antenna element 108A and the metal pad 212A are electrically connected through the TGV 112A. As another example, the antenna element 108B and the metal pad 212B are electrically connected through the TGV 112B. Optionally, in some aspects, the second metal layer, the metal pads 212A-D, or a combination thereof are thinned after deposition, e.g., using etching or grinding processes.

Stage 4 illustrates a state after a mold compound 122 is disposed on the antenna elements 108 and the side 144 of the glass layer 104, and after substrate 140 is disposed on the metal pads 212 and the side 142 of the glass layer 104. In a particular example, a deposition process, a spin-on process, or a similar process can be used to apply the mold compound 122 and one or more patterning processes are applied to the mold compound 122 to define openings 812, such as an opening 812A aligned with the lens 106A and an opening 812B aligned with the lens 106B. In an alternative example, a pattern is formed (e.g., in photo resist) on the side 144, the mold compound 122 is applied on the pattern, and the pattern is removed to define the openings 812. The mold compound 122 can subsequently be cured or hardened by exposure to light, heat, and/or chemical hardening agents.

One or more plating processes and one or more patterning processes can be used to deposit insulators, such as an insulator layer 222A on the metal pad 212B and an insulator layer 222B on the metal pad 212D. One or more plating processes and one or more patterning processes can be used to form metal pads on the insulators. For example, a metal pad 224A is formed on the insulator layer 222A and a metal pad 224B is formed on the insulator layer 222B.

One or more additional layers can be formed on the metal pads 212 and 224 to form portions of passive components, to provide conductive paths for electrical interconnection, etc. To illustrate, Stage 4 of FIG. 8 illustrates an example that includes additional dielectric layers, vias, and metal pads. For example, a dielectric layer 202A and a dielectric layer 202B are deposited and openings are formed in the dielectric layers 202A-B using patterning operations, etching processes, drilling operations, laser ablation operations, other targeted dielectric removal operations, or combinations thereof. To illustrate, a first opening is formed in the dielectric layer 202A to the metal pad 212A, a second opening is formed in the dielectric layer 202A to the metal pad 224A, a third opening is formed in the dielectric layer 202B to the metal pad 212C, and a fourth opening is formed in the dielectric layer 202B to the metal pad 224B. A conductive material is deposited in the openings to form vias and metal pads (e.g., a metal pad 214A, a metal pad 214B, a metal pad 214C, and a metal pad 214D) on the vias.

As another example, a dielectric layer 204A and a dielectric layer 204B are deposited and openings are formed in the dielectric layers 204A-B using patterning operations, etching processes, drilling operations, laser ablation operations, other targeted dielectric removal operations, or combinations thereof. To illustrate, a first opening is formed in the dielectric layer 204A to the metal pad 214A, a second opening is formed in the dielectric layer 204A to the metal pad 214B, a third opening is formed in the dielectric layer 204B to the metal pad 214C, and a fourth opening is formed in the dielectric layer 204B to the metal pad 214D. A conductive material is deposited in the openings to form vias and metal pads (e.g., a metal pad 216A, a metal pad 216B, a metal pad 216C, and a metal pad 216D) on the vias. In an example, a dielectric layer 206A and a dielectric layer 206B are deposited.

Passive elements 130 are thus formed on the side 142 of the glass layer 104. For example, passive elements 130A including an inductor 132A and a capacitor 134A are embedded in a substrate 140A and passive elements 130B including an inductor 132B and a capacitor 134B are embedded in a substrate 140B.

Stage 5 illustrates a state after attachment with the die 118. For example, heating/reflowing the conductive interconnects 126 is used to connect the die 118 to the substrate 140. The conductive interconnects 126 A-B can include a grid or array of bumps including the conductive interconnect 126A providing electrical connections between the passive elements 130A and the photo diode 110A of the die 118 and the conductive interconnect 126B providing electrical connections between the passive elements 130B and the photo diode 110B of the die 118.

Stage 6 in FIG. 9 illustrates a state after a sealant layer 114 is deposited. For example, the sealant layer 114 at least partially encapsulates the conductive interconnect 126A, the conductive interconnect 126B, the photo diode 110A, the photo diode 110B, the die 118, the lens 106A, the lens 106B, or a combination thereof. In a particular aspect, the sealant layer 114 encapsulates a volume between the lenses 106 and the photo diodes 110.

Stage 7 illustrates a state after optical fibers 102 are directly attached to the glass layer 104. For example, an end of the optical fiber 102A is inserted in the opening 812A to connect to a first portion on the side 144 of the glass layer 104. As another example, an end of the optical fiber 102B is inserted in the opening 812B to connect to a second portion on the side 144 of the glass layer 104. To illustrate, the end of the optical fiber 102A is fused or adhered to the first portion of the glass layer 104 and the end of the optical fiber 102B is fused or adhered to the second portion of the glass layer 104.

Formation of the device 100 is complete after Stage 7 of FIG. 9. However, in some implementations, conductive interconnects 526 are attached to the device 100 to form the device 500. Stage 8 illustrates a state after attachment of the conductive interconnect 526A to the metal pad 216A and the conductive interconnect 526B to the metal pad 216D. Formation of the device 500 is complete after stage 8. The antenna elements 108 formed on the side 144 is provided as an illustrative example, in other examples the antenna elements 108 can be formed on the side 142, as described with reference to FIGS. 7A-7B.

Various other antenna devices with fiber attached glass can be fabricated. For example, fabrication of the device 300 can include a Stage 2 in which openings are defined in the glass layer 104 and the optical fibers 102 are inserted in the openings to extend through the glass layer 104 and the lenses 106 are attached to ends of the optical fibers 102. For example, the lens 106A is attached (e.g., adhered or fused) to an end of the optical fiber 102A and the lens 106B is attached (e.g., adhered or fused) to an end of the optical fiber 102B. Fabrication of the device 300 proceeds from Stage 2 to Stage 5 where the die 118 is attached (e.g., adhered) to the glass layer 104. Conductive interconnects 326A and 326B are formed on a side of the die 118 that is opposite the glass layer 104 and are used to attach the die 118 to the laminate substrate 340 that includes passive elements 130. For example, heating/reflowing the conductive interconnects 326 is used to connect the die 118 to the laminate substrate 340. The antenna elements 108 are formed on a side of the laminate substrate 340 that is opposite the die 118. In some examples, metal layers are deposited and subsequently patterned, and in other examples, a patterning layer (e.g., a photoresist layer) is applied to the laminate substrate 340 and used to guide formation of the antenna elements 108. A mold compound 122 is disposed on the die 118 and the laminate substrate 340. The mold compound 122 at least partially encapsulates the optical fibers 102, the die 118, the conductive interconnects 326, a side of the laminate substrate 340, or a combination thereof. In a particular example, a deposition process, a spin-on process, or a similar process can be used to apply the mold compound 122. The mold compound 122 can subsequently be cured or hardened by exposure to light, heat, and/or chemical hardening agents to complete the formation of the device 300.

As another example, fabrication of the device 400 can include a similar Stage 2 as fabrication of the device 300 in which the optical fibers 102 are extend through the glass layer 104 and ends of the optical fibers 102 are attached to lenses 106. Stage 3 of fabrication of the device 400 is similar to Stage 3 of FIG. 8 with a single TGV on each side of the lenses 106 that electrically connects an antenna element to a metal pad. For example, the TGV 112A electrically connects the antenna element 108A to the metal pad 412A and the TGV 112B electrically connects the antenna element 108B to the metal pad 412B. Stages 4-6 of fabrication of the device 400 are similar to Stages 4-6 of FIGS. 8-9 for formation of the passive elements 130A and the passive elements 130B, attachment of the die 118, and deposition of the sealant layer 114. A mold compound 122 is disposed on the antenna elements 108, the glass layer 104, the substrate 140, and the sealant layer 114. The mold compound 122 at least partially encapsulates the optical fibers 102, the antenna elements 108, the substrate 140, the sealant layer 114, or a combination thereof. In a particular example, a deposition process, a spin-on process, or a similar process can be used to apply the mold compound 122. The mold compound 122 can subsequently be cured or hardened by exposure to light, heat, and/or chemical hardening agents to complete the formation of the device 400.

In an example, fabrication of the device 600 includes a Stage 2 in which various gradient index (GRIN) lens formation techniques (e.g., neutron irradiation, chemical vapor deposition, ion exchange, or a combination thereof) are used to form the lens 106A and the lens 106B in the glass layer 104. In Stage 3, optical fibers 102 are attached (e.g., adhered or fused) to the glass layer 104. A die 118 is attached (e.g., adhered) to the glass layer 104. Conductive interconnects 626A and 626B are formed on a side of the die 118 that is opposite the glass layer 104 and are used to attach the die 118 to a laminate substrate 340 that includes passive elements 130. For example, heating/reflowing the conductive interconnects 626 is used to connect the die 118 to the laminate substrate 340. Similarly, conductive interconnects 628A and 628B are used to attach the die 618 to the laminate substrate 340.

The antenna elements 108 are formed on a side of the laminate substrate 340 that is opposite the die 118 and the die 618. In some examples, metal layers are deposited and subsequently patterned, and in other examples, a patterning layer (e.g., a photoresist layer) is applied to the laminate substrate 340 and used to guide formation of the antenna elements 108. A mold compound 122 is disposed on the die 118, the die 618, and a side of the laminate substrate 340. The mold compound 122 at least partially encapsulates the optical fibers 102, the die 118, the die 618, the conductive interconnects 626, the conductive interconnects 628, the side of the laminate substrate 340, or a combination thereof. In a particular example, a deposition process, a spin-on process, or a similar process can be used to apply the mold compound 122. The mold compound 122 can subsequently be cured or hardened by exposure to light, heat, and/or chemical hardening agents to complete the formation of the device 600.

In an example, fabrication of the device 700 includes Stage 2 of FIG. 8 in which the lenses 106 are formed on or in the glass layer 104. Stage 3 of fabrication of the device 700 includes forming metal pads 708 on the same side 142 of the glass layer 104 that has the lenses 106. In some examples, metal layers are deposited and subsequently patterned, and in other examples, a patterning layer (e.g., a photoresist layer) is applied to the glass layer 104 and used to guide formation of metal pads 708. RDL fabrication processes (e.g., spinning, photolithography, etching, sputtering, electroplating, or a combination thereof) are used to form the RDL 702A and the RDL 702B. Openings are formed in the RDLs 702 using patterning operations, etching processes, drilling operations, laser ablation operations, other targeted RDL removal operations, or combinations thereof. The openings are filled with a conductive material to form vias, metal pads 718, and antenna elements 108. Similar to Stages 5-7 of FIGS. 8-9, the conductive interconnects 126 are used to attach the die 118, a sealant layer 114 is deposited, and the optical fibers 102 are directly attached to the glass layer 104. In a particular aspect, the mold compound 122 is removed to complete the fabrication of the device 700.

In an example, fabrication of the device 714 includes Stage 2 of FIG. 8 in which the lenses 106 are formed on or in the glass layer 104. Stage 3 of fabrication of the device 714 includes forming metal pads 728 on the same side 142 of the glass layer 104 that has the lenses 106. In some examples, metal layers are deposited and subsequently patterned, and in other examples, a patterning layer (e.g., a photoresist layer) is applied to the glass layer 104 and used to guide formation of metal pads 728. Stage 4 of fabrication of the device 714 is similar to Stage 4 of FIG. 8 for formation of the passive elements 130A and the passive elements 130B. Additionally, antenna elements 108 are formed. In some examples, the antenna elements 108 are formed concurrently with forming the metal pads 216.

Stages 5-7 of fabrication of the device 714 are similar to Stages 5-7 of FIGS. 8-9 for attachment of the die 118, deposition of the sealant layer 114, and attachment of the optical fibers 102 to the glass layer 104. In a particular aspect, the mold compound 122 is removed to complete the fabrication of the device 714.

Exemplary Flow Diagram of a Method for Fabricating an Antenna Device with Fiber Attached Glass

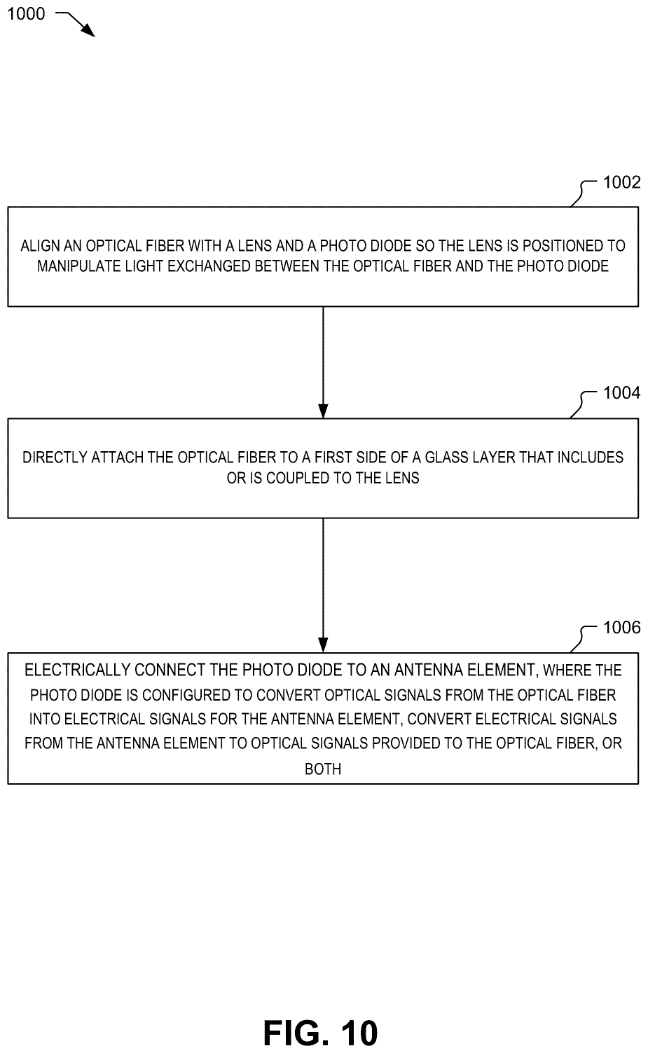

In some implementations, fabricating an antenna device includes several processes. FIG. 10 illustrates an exemplary flow diagram of a method 1000 for providing or fabricating an antenna device. In some implementations, the method 1000 of FIG. 10 may be used to provide or fabricate any of the devices 100, 300, 400, 500, 600, 700, or 714 of FIGS. 1-7B.

It should be noted that the method 1000 of FIG. 10 may combine one or more processes in order to simplify and/or clarify the method for providing or fabricating an integrated device. In some implementations, the order of the processes may be changed or modified.

The method 1000 includes, at block 1002, aligning an optical fiber with a lens and a photo diode so the lens is positioned to manipulate light exchanged between the optical fiber and the photo diode. For example, the optical fiber 102A is aligned with the lens 106A and the photo diode 110A so the lens 106A is positioned to manipulate light exchanged between the optical fiber 102A and the photo diode 110A. In some implementations, Stage 2 of FIG. 8 illustrates examples of forming the lenses 106 on the glass layer 104. In some aspects, locations of the lenses 106 on the glass layer are aligned with predetermined locations of photo diodes 110 on the die 118. Stage 4 of FIG. 8 illustrates examples of defining the openings 812 that are aligned with the lenses 106 and Stage 7 of FIG. 9 illustrates inserting the optical fibers 102 in the openings 812 so that the optical fibers 102 are aligned with the lenses 106 and the photo diodes 110.

The method 1000 includes, at block 1004, directly attaching the optical fiber to a first side of a glass layer that includes or is coupled to the lens. For example, the optical fiber 102A is directly attached (e.g., fused or adhered) to the side 144 of the glass layer 104 that includes or is coupled to the lens 106A. In some implementations, Stage 7 of FIG. 9 illustrates directly attaching the optical fiber 102A to the side 144 of the glass layer 104 that includes the lens 106A.

The method 1000 includes, at block 1006, electrically connecting the photo diode to an antenna element, where the photo diode is configured to convert optical signals from the optical fiber into electrical signals for the antenna element, convert electrical signals from the antenna element to optical signals provided to the optical fiber, or both. For example, the photo diode 110A is electrically connected to an antenna element 108B of FIG. 1 and the photo diode 110A is configured to convert optical signals from the optical fiber 102A into electrical signals for the antenna element 108B, convert electrical signals from the antenna element 108B to optical signals provided to the optical fiber 102A, or both. In some implementations, Stage 5 of FIG. 8 illustrates electrically connecting the photo diode 110A through the conductive interconnect 126A, the capacitor 134A, and the TGV 112B to the antenna element 108B.

### Exemplary Electronic Devices

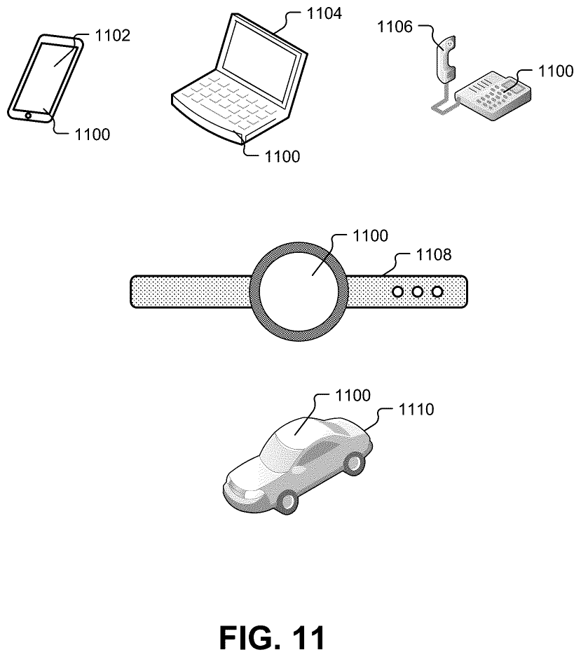

FIG. 11 illustrates various electronic devices that may include or be integrated with any of the antenna devices 100, 300, 400, 500, 600, 700, or 714. For example, a mobile phone device 1102, a laptop computer device 1104, a fixed location terminal device 1106, a wearable device 1108, or a vehicle 1110 (e.g., an automobile or an aerial device) may include a device 1100. The device 1100 can include, for example, any of the devices 100, 300, 400, 500, 600, 700, or 714 described herein. The devices 1102, 1104, 1106 and 1108 and the vehicle 1110 illustrated in FIG. 11 are merely exemplary. Other electronic devices may also feature the device 1100 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices (e.g., watches, glasses), Internet of things (IoT) devices, servers, routers, electronic devices implemented in vehicles (e.g., autonomous vehicles), or any other device that stores or retrieves data or computer instructions, or any combination thereof.

One or more of the components, processes, features, and/or functions illustrated in FIGS. 1-11 may be rearranged and/or combined into a single component, process, feature or function or embodied in several components, processes, or functions. Additional elements, components, processes, and/or functions may also be added without departing from the disclosure. It should also be noted FIGS. 1-11 and its corresponding description in the present disclosure is not limited to dies and/or ICs. In some implementations, FIGS. 1-11 and its corresponding description may be used to manufacture, create, provide, and/or produce devices and/or integrated devices. In some implementations, a device may include a die, an integrated device, an integrated passive device (IPD), a die package, an integrated circuit (IC) device, a device package, an integrated circuit (IC) package, a wafer, a semiconductor device, a package-on-package (POP) device, a heat dissipating device and/or an interposer.

It is noted that the figures in the disclosure may represent actual representations and/or conceptual representations of various parts, components, objects, devices, packages, integrated devices, integrated circuits, and/or transistors. In some instances, the figures may not be to scale. In some instances, for purpose of clarity, not all components and/or parts may be shown. In some instances, the position, the location, the sizes, and/or the shapes of various parts and/or components in the figures may be exemplary. In some implementations, various components and/or parts in the figures may be optional.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling (e.g., mechanical coupling) between two objects. For example, if object A physically touches object B, and object B touches object C, then objects A and C may still be considered coupled to one another-even if they do not directly physically touch each other. An object A, that is coupled to an object B, may be coupled to at least part of object B. The term “electrically coupled” may mean that two objects are directly or indirectly coupled together such that an electrical current (e.g., signal, power, ground) may travel between the two objects. Two objects that are electrically coupled may or may not have an electrical current traveling between the two objects. The use of the terms “first”, “second”, “third” and “fourth” (and/or anything above fourth) is arbitrary. Any of the components described may be the first component, the second component, the third component or the fourth component. For example, a component that is referred to as a second component, may be the first component, the second component, the third component or the fourth component. The terms “encapsulate”, “encapsulating” and/or any derivation means that the object may partially encapsulate or completely encapsulate another object. The terms “top” and “bottom” are arbitrary. A component that is located on top may be located over a component that is located on a bottom. A top component may be considered a bottom component, and vice versa. As described in the disclosure, a first component that is located “over” a second component may mean that the first component is located above or below the second component, depending on how a bottom or top is arbitrarily defined. In another example, a first component may be located over (e.g., above) a first surface of the second component, and a third component may be located over (e.g., below) a second surface of the second component, where the second surface is opposite to the first surface. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. A first component that is located “in” a second component may be partially located in the second component or completely located in the second component. A value that is about X-XX, may mean a value that is between X and XX, inclusive of X and XX. The value(s) between X and XX may be discrete or continuous. The term “about ‘value X’”, or “approximately value X”, as used in the disclosure means within 10 percent of the ‘value X’. For example, a value of about 1 or approximately 1, would mean a value in a range of 0.9-1.1. A “plurality” of components may include all the possible components or only some of the components from all of the possible components. For example, if a device includes ten components, the use of the term “the plurality of components” may refer to all ten components or only some of the components from the ten components.

In some implementations, an interconnect is an element or component of a device or package that allows or facilitates an electrical connection between two points, elements and/or components. In some implementations, an interconnect may include a trace, a via, a pad, a pillar, a metallization layer, a redistribution layer, and/or an under bump metallization (UBM) layer/interconnect. In some implementations, an interconnect may include an electrically conductive material that may be configured to provide an electrical path for a signal (e.g., a data signal), ground and/or power. An interconnect may include more than one element or component. An interconnect may be defined by one or more interconnects. An interconnect may include one or more metal layers. An interconnect may be part of a circuit. Different implementations may use different processes and/or sequences for forming the interconnects. In some implementations, a chemical vapor deposition (CVD) process, a physical vapor deposition (PVD) process, a sputtering process, a spray coating, and/or a plating process may be used to form the interconnects.

Also, it is noted that various disclosures contained herein may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed.

In the following, further examples are described to facilitate the understanding of the disclosure.

According to Example 1, a device comprises: a glass layer; an optical fiber directly attached to the glass layer; a photo diode electrically connected to an antenna element; and a lens coupled to or included within the glass layer and configured to manipulate light exchanged between the optical fiber and the photo diode, wherein the photo diode is configured to convert optical signals from the optical fiber into electrical signals for the antenna element, convert electrical signals from the antenna element to optical signals provided to the optical fiber, or both.

Example 2 includes the device of Example 1, wherein the light exchanged between the optical fiber and the photo diode passes through the glass layer.

Example 3 includes the device of Example 1 or 2, wherein the optical fiber is fused to the glass layer.

Example 4 includes the device of Example 1 or 2, wherein the optical fiber is adhered to the glass layer.

Example 5 includes the device of any of Examples 1 to 4, wherein the lens corresponds to a shaped portion of the glass layer.

Example 6 includes the device of any of Examples 1 to 4, wherein the lens corresponds to a gradient index lens included within the glass layer.

Example 7 includes the device of any of Examples 1 to 4, wherein the lens is adhered to the glass layer.

Example 8 includes the device of any of Examples 1 to 7, wherein the optical fiber is directly attached to a first side of the glass layer, and wherein the photo diode is on a second side of the glass layer that is opposite the first side of the glass layer.

Example 9 includes the device of Example 8, wherein the antenna element is adjacent to the first side of the glass layer.

Example 10 includes the device of Example 8 or 9, wherein the photo diode is adjacent to the second side of the glass layer.

Example 11 includes the device of Example 8 or 9, wherein a distance between the second side of the glass layer and the photo diode corresponds to a focal length of the lens.

Example 12 includes the device of any of Examples 8 to 11, wherein the antenna element is on the second side of the glass layer.

Example 13 includes the device of any of Examples 8 to 12, further comprising one or more passive elements on the second side of the glass layer.

Example 14 includes the device of Example 13, wherein the one or more passive elements include at least one capacitor, at least one inductor, or a combination thereof.

Example 15 includes the device of any of Examples 8 to 14, further comprising a passive element integrated within the glass layer and including features on the first side of the glass layer and the second side of the glass layer.

Example 16 includes the device of any of Examples 1 to 15, further comprising a sealant layer that encapsulates a volume that includes the photo diode and the lens.

Example 17 includes the device of any of Examples 1 to 16, further comprising a laminate substrate that is between the photo diode and the antenna element.

Example 18 includes the device of Example 17, wherein the antenna element is adjacent to a first side of the laminate substrate.

Example 19 includes the device of Example 17 or 18, further comprising one or more passive elements coupled to or embedded within the laminate substrate.

Example 20 includes the device of any of Examples 17 to 19, wherein the photo diode is embedded in a die and wherein a second device is coupled to the die via the laminate substrate.

Example 21 includes the device of Example 20, wherein the second device includes a transmitter, a receiver, a transceiver, a low-noise amplifier, a power amplifier, a passive device, or a combination thereof.

Example 22 includes the device of any of Examples 1 to 21, further comprising a mold compound at least partially encapsulating the glass layer, the optical fiber, the photo diode, the lens, or a combination thereof.

Example 23 includes the device of any of Examples 1 to 22, further comprising: a second optical fiber directly attached to the glass layer; a second photo diode electrically connected to a second antenna element, wherein an antenna array includes the antenna element and the second antenna element; and a second lens coupled to or included within the glass layer and configured to manipulate light exchanged between the second optical fiber and the second photo diode, wherein the second photo diode is configured to convert optical signals from the second optical fiber into electrical signals for the second antenna element, convert electrical signals from the second antenna element to optical signals provided to the second optical fiber, or both.

Example 24 includes the device of Example 23, wherein a pitch distance between a center of a first connection of the optical fiber to the glass layer and a center of a second connection of the second optical fiber to the glass layer is less than 0.2 millimeters (mm).

According to Example 25, a method of fabricating a device comprises: aligning an optical fiber with a lens and a photo diode so the lens is positioned to manipulate light exchanged between the optical fiber and the photo diode; directly attaching the optical fiber to a first side of a glass layer that includes or is coupled to the lens; and electrically connecting the photo diode to an antenna element, wherein the photo diode is configured to convert optical signals from the optical fiber into electrical signals for the antenna element, convert electrical signals from the antenna element to optical signals provided to the optical fiber, or both.

Example 26 includes the method of Example 25, further comprising shaping a portion of the glass layer to form the lens.

Example 27 includes the method of Example 25 or 26, further comprising forming the antenna element on the first side of the glass layer.

Example 28 includes the method of any of Examples 25 to 27, further comprising forming one or more passive elements on a second side of the glass layer that is opposite the first side of the glass layer.

Example 29 includes the method of Example 28, further comprising forming the antenna element on the second side of the glass layer.

Example 30 includes the method of any of Examples 25 to 29, wherein directly attaching the optical fiber to the first side of the glass layer includes fusing the optical fiber to the first side of the glass layer.

According to Example 31, a device comprises: a glass layer; a plurality of optical fibers directly attached to the glass layer; a plurality of antenna elements; a plurality of photo diodes, a particular photo diode of the plurality of photo diodes electrically connected to a corresponding antenna element of the plurality of antenna elements; and a plurality of lenses coupled to or included within the glass layer, a particular lens of the plurality of lenses configured to manipulate light exchanged between a particular optical fiber and the particular photo diode, wherein the particular photo diode is configured to convert optical signals from the particular optical fiber into electrical signals for the corresponding antenna element, convert electrical signals from the corresponding antenna element to optical signals provided to the particular optical fiber, or both.

Example 32 includes the device of Example 31, further comprising a laminate substrate between the plurality of photo diodes and the plurality of antenna elements.

The various features of the disclosure described herein can be implemented in different systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. A device comprising:
a glass layer;
an optical fiber directly attached to the glass layer;
a photo diode electrically connected to an antenna element; and
a lens coupled to or included within the glass layer and configured to manipulate light exchanged between the optical fiber and the photo diode,
wherein the photo diode is configured to convert optical signals from the optical fiber into electrical signals for the antenna element, convert electrical signals from the antenna element to optical signals provided to the optical fiber, or both.

2. The device of claim 1, wherein the light exchanged between the optical fiber and the photo diode passes through the glass layer.

3. The device of claim 1, wherein the optical fiber is fused to the glass layer.

4. The device of claim 1, wherein the optical fiber is adhered to the glass layer.

5. The device of claim 1, wherein the lens corresponds to a shaped portion of the glass layer.

6. The device of claim 1, wherein the lens corresponds to a gradient index lens included within the glass layer.

7. The device of claim 1, wherein the lens is adhered to the glass layer.

8. The device of claim 1, wherein the optical fiber is directly attached to a first side of the glass layer, and wherein the photo diode is on a second side of the glass layer that is opposite the first side of the glass layer.

9. The device of claim 8, wherein the antenna element is adjacent to the first side of the glass layer.

10. The device of claim 8, wherein the photo diode is adjacent to the second side of the glass layer.

11. The device of claim 8, wherein a distance between the second side of the glass layer and the photo diode corresponds to a focal length of the lens.

12. The device of claim 8, wherein the antenna element is on the second side of the glass layer.

13. The device of claim 8, further comprising one or more passive elements on the second side of the glass layer.

14. The device of claim 13, wherein the one or more passive elements include at least one capacitor, at least one inductor, or a combination thereof.

15. The device of claim 8, further comprising a passive element integrated within the glass layer and including features on the first side of the glass layer and the second side of the glass layer.

16. The device of claim 1, further comprising a sealant layer that encapsulates a volume that includes the photo diode and the lens.

17. The device of claim 1, further comprising a laminate substrate that is between the photo diode and the antenna element.

18. The device of claim 17, wherein the antenna element is adjacent to a first side of the laminate substrate.

19. The device of claim 17, further comprising one or more passive elements coupled to or embedded within the laminate substrate.

20. The device of claim 17, wherein the photo diode is embedded in a die and wherein a second device is coupled to the die via the laminate substrate.

21. The device of claim 20, wherein the second device includes a transmitter, a receiver, a transceiver, a low-noise amplifier, a power amplifier, a passive device, or a combination thereof.

22. The device of claim 1, further comprising a mold compound at least partially encapsulating the glass layer, the optical fiber, the photo diode, the lens, or a combination thereof.

23. The device of claim 1, further comprising:
a second optical fiber directly attached to the glass layer;
a second photo diode electrically connected to a second antenna element, wherein an antenna array includes the antenna element and the second antenna element; and
a second lens coupled to or included within the glass layer and configured to manipulate light exchanged between the second optical fiber and the second photo diode,
wherein the second photo diode is configured to convert optical signals from the second optical fiber into electrical signals for the second antenna element, convert electrical signals from the second antenna element to optical signals provided to the second optical fiber, or both.

24. The device of claim 23, wherein a pitch distance between a center of a first connection of the optical fiber to the glass layer and a center of a second connection of the second optical fiber to the glass layer is less than 0.2 millimeters (mm).

25. A method of fabricating a device, the method comprising:
aligning an optical fiber with a lens and a photo diode so the lens is positioned to manipulate light exchanged between the optical fiber and the photo diode;
directly attaching the optical fiber to a first side of a glass layer that includes or is coupled to the lens; and
electrically connecting the photo diode to an antenna element,
wherein the photo diode is configured to convert optical signals from the optical fiber into electrical signals for the antenna element, convert electrical signals from the antenna element to optical signals provided to the optical fiber, or both.

26. The method of claim 25, further comprising shaping a portion of the glass layer to form the lens.

27. The method of claim 25, further comprising forming the antenna element on the first side of the glass layer.

28. The method of claim 25, further comprising forming one or more passive elements on a second side of the glass layer that is opposite the first side of the glass layer.

29. The method of claim 28, further comprising forming the antenna element on the second side of the glass layer.

30. The method of claim 25, wherein directly attaching the optical fiber to the first side of the glass layer includes fusing the optical fiber to the first side of the glass layer.

31. A device comprising:
a glass layer;
a plurality of optical fibers directly attached to the glass layer;
a plurality of antenna elements;
a plurality of photo diodes, a particular photo diode of the plurality of photo diodes electrically connected to a corresponding antenna element of the plurality of antenna elements; and
a plurality of lenses coupled to or included within the glass layer, a particular lens of the plurality of lenses configured to manipulate light exchanged between a particular optical fiber and the particular photo diode,
wherein the particular photo diode is configured to convert optical signals from the particular optical fiber into electrical signals for the corresponding antenna element, convert electrical signals from the corresponding antenna element to optical signals provided to the particular optical fiber, or both.

32. The device of claim 31, further comprising a laminate substrate between the plurality of photo diodes and the plurality of antenna elements.
